(19) United States
(12) Patent Application Publication
(10) Pub. No.: US 2026/0045269 A1
(43) Pub. Date: Feb. 12, 2026

(54) PLAYBACK LOUDNESS PROCESSING METHOD OF MEDIA DATA, ELECTRONIC DEVICE, AND MEDIUM

(71) Applicant: Beijing Zitiao Network Technology Co., Ltd., Beijing (CN)

(72) Inventor: Ye MA, Beijing (CN)

(21) Appl. No.: 19/274,397

(22) Filed: Jul. 18, 2025

(30) Foreign Application Priority Data
Aug. 8, 2024 (CN) 202411087752.6

(51) Int. Cl. G10L 21/034; G10L 25/78

(52) U.S. Cl. CPC G10L 21/034; G10L 25/78

(57) ABSTRACT

The present disclosure relates to the computer processing technology, discloses a playback loudness processing method and apparatus of media data, an electronic device, and a storage medium. The playback loudness processing method of media data includes: obtaining media data; determining, in response to the media data including speech data, speech loudness metadata of the speech data based on a speech loudness distribution result corresponding to the speech data; and adjusting playback loudness of the media data based on the speech loudness metadata to obtain target media data for playback.

### CROSS-REFERENCE TO RELATED APPLICATION

The present application claims the priority of the Chinese Patent Application No. 202411087752.6 filed on Aug. 8, 2024, the entire contents disclosed by the Chinese patent application are hereby incorporated by reference as a part of the present application.

### TECHNICAL FIELD

The present disclosure relates to the technical field of computer processing technology, in particularly to a playback loudness processing method and apparatus of media data, an electronic device, and a storage medium.

### BACKGROUND

When media data is played on a terminal, the loudness at publication varies due to differences in the creation of different media data. Therefore, in order to ensure equalization of playback loudness when the media data are played on a terminal side, equalization adjustment is performed based on overall playback loudness of the media data. However, the use of this approach of loudness equalization is prone to a large difference in speech loudness in different media data, which affects user experience.

### SUMMARY

With this regard, the present disclosure provides a playback loudness processing method and apparatus of media data, an electronic device, and a storage medium, to solve the problem of equalization of playback loudness.

At a first aspect, the present disclosure provides a playback loudness processing method of media data, which includes:
obtaining media data;
determining, in response to the media data including speech data, speech loudness metadata of the speech data based on a speech loudness distribution result corresponding to the speech data; and
adjusting playback loudness of the media data based on the speech loudness metadata to obtain target media data for playback.

At a second aspect, the present disclosure provides a playback loudness processing apparatus of media data, which includes:
a first obtaining module, configured to obtain media data;
a first processing module, configured to determine, in response to the media data including speech data, speech loudness metadata of the speech data based on a speech loudness distribution result corresponding to the speech data; and
a second processing module, configured to adjust playback loudness of the media data based on the speech loudness metadata to obtain target media data for playback.

At a third aspect, the present disclosure provides an electronic device, which includes: a memory and a processor, the memory and the processor are in communication connection with each other, the memory stores a computer instruction, and the processor executes the computer instruction to perform a playback loudness processing method of media data according to the first aspect and any one embodiment corresponding to the first aspect.

At a fourth aspect, the present disclosure provides a computer-readable storage medium, storing a computer instruction, the computer instruction being configured to cause a computer to perform a playback loudness processing method of media data according to the first aspect and any one embodiment corresponding to the first aspect.

At a fifth aspect, the present disclosure provides a computer program product, including a computer instruction, the computer instruction being configured to cause a computer to perform a playback loudness processing method of media data according to the first aspect and any one embodiment corresponding to the first aspect.

### BRIEF DESCRIPTION OF DRAWINGS

In order to more clearly illustrate the technical solutions in the specific embodiments of the present disclosure or in the prior art, the following will provide a brief introduction to the drawings that are needed in the description of the specific embodiments or the prior art. It is obvious that the drawings described below are some embodiments of the present disclosure. For those skilled in the art, other drawings can also be obtained based on these drawings without making creative efforts.

FIG. 1 is a schematic flowchart of a playback loudness processing method of media data according to an embodiment of the present disclosure;

FIG. 2 is a schematic diagram of a speech loudness distribution result according to an embodiment of the present disclosure;

FIG. 3 is a schematic flowchart of another playback loudness processing method of media data according to an embodiment of the present disclosure;

FIG. 4 is a schematic flowchart of yet another playback loudness processing method of media data according to an embodiment of the present disclosure;

FIG. 5 is a schematic flowchart of still another playback loudness processing method of media data according to an embodiment of the present disclosure;

FIG. 6 is a schematic flowchart of a playback loudness processing method of media data according to an embodiment of the present disclosure;

FIG. 7 is a block diagram of a playback loudness processing apparatus of media data according to an embodiment of the present disclosure;

FIG. 8 is a schematic structural diagram of hardware of an electronic device according to an embodiment of the present disclosure.

### DETAILED DESCRIPTION

To make the objectives, technical solutions, and advantages of the embodiments of the present disclosure clearer, the following will describe the technical solutions in the embodiments of the present disclosure clearly and completely in conjunction with the drawings in the embodiments of the present disclosure. It is obvious that the described embodiments are only some, not all, of the embodiments of the present disclosure. Any other embodiments obtained by those skilled in the art without making creative efforts based on the embodiments of the present disclosure are within the scope of protection of the present disclosure.

In related technology, in the processing of loudness on a playback side, adjustment is based on programme loudness of an audio. When speech loudness in the audio is out of balance, it will lead to a more obvious change in loudness, i.e., there exists a situation in which part of the speech is louder, and part of the speech is smaller, which will affect user experience.

In view of this, embodiments of the present disclosure provide a playback loudness processing method of media data to solve the problem that user has different loudness experiences in adjacent speech audio when playing media data.

According to an embodiment of the present disclosure, an embodiment of a playback loudness processing method of media data is provided. It should be noted that steps illustrated in the flowchart of the accompanying drawings may be performed in a computer system having a set of computer-executable instructions and the like, and that, although a logical order is illustrated in the flowchart, the steps illustrated or described may be performed in a different order in some cases from that shown herein.

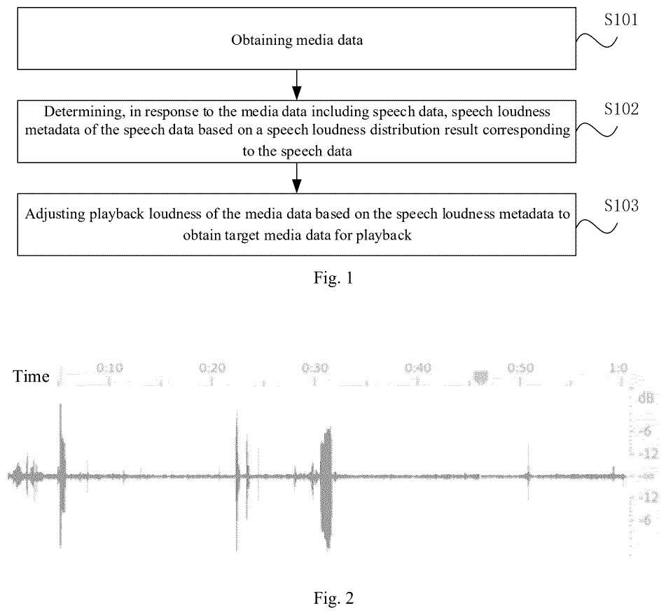

In the present embodiment, a playback loudness processing method of media data is provided, and may be used in a mobile terminal described above, such as a cellphone and a tablet PC. FIG. 1 is a flowchart of a playback loudness processing method of media data according to an embodiment of the present disclosure. As illustrated by FIG. 1, the method includes the following steps.
Step S101: obtaining media data.

The media data is to-be-played media data received by a playback side, includes but not limited to, a video or an audio. The form of the media data is not limited here, but is set according to the actual needs. For example, the playback side is installed with a short video playback application, and the user extracts a corresponding video, i.e., the media data, from a server of the short video playback application when using the short video playback application to play a short video.
Step S102: determining, in response to the media data including speech data, speech loudness metadata of the speech data based on a speech loudness distribution result corresponding to the speech data.

When it is determined that the media data includes the speech data, the speech loudness distribution of the speech data is analyzed to obtain the speech loudness distribution result as illustrated by FIG. 2.

Speech descriptive information such as average loudness (integrated loudness), loudness range, and loudness variation of the speech data may be determined through the speech loudness distribution result, thereby obtaining the speech loudness metadata capable of characterizing audio characteristics of the speech data.

In some examples, the content of the speech loudness metadata includes, but is not limited to, any one or more of the following information: ratio of the speech data in the media data (speech_ratio), dialogue loudness, speech loudness, integrated loudness (integrated_loudness), start loudness of loudness range (LRA_start), end loudness of loudness range (LRA_end), maximum momentary loudness (max_mom_loud), maximum short-term loudness (max_short_term_loud), and the like.
Step S103: adjusting playback loudness of the media data based on the speech loudness metadata to obtain target media data for playback.

Loudness distribution of the speech data in the media data may be determined through the speech loudness metadata, and then, the targeted equalization processing can be carried out for the programme loudness of the speech data during adjustment of playback loudness of the media data, thereby effectively improving the playback effect of the target media data obtained subsequently.

In the playback loudness processing method of the media data of the present disclosure, the speech loudness metadata of the speech data is determined based on the loudness distribution result corresponding to the speech data in the media data, and then the playback loudness of the media data is adjusted based on the speech loudness metadata, enabling to ensure that the loudness of the speech data after adjusting in the target media data is equalized, thereby helping to improve the playback effect of the media data.

In some optional implementations, the process of determining the speech loudness distribution result corresponding to the speech data includes:
Step a1: performing speech detection on the media data to determine a media data fragment corresponding to the speech data in the media data;
Step a2: determining loudness distribution of the media data fragment to obtain a loudness distribution result; and
Step a3: determining the speech loudness distribution result corresponding to the speech data according to the loudness distribution result.

Specifically, in order to recognize the speech data in the media data, the speech detection is performed on the media data, to separate the speech data from background audio data in the media data, thus obtaining the media data fragment corresponding to the speech data. The content in the media data fragment includes, but is not limited to, a word, a dialogue, a sentence, a continuous language, and the like. In some optional implementation scenarios, the speech detection may be performed on the media data based on audio features (e.g., root mean square (RMS) value) by creating an audio event detection (AED) task. For example, the media data is processed to calculate the RMS value for each time point or time period separately. A suitable RMS threshold is determined according to the audio features of the speech data and application requirements. The selection of the RMS threshold may need to be adjusted empirically or experimentally. The RMS value obtained at a current point in time or in a current time period is compared to the threshold. When the calculated RMS value is greater than the RMS or is equal to the threshold, it is considered that the speech data exists; when the RMS value is less than the RMS threshold, it is considered that no speech data exists.

After the media data fragment is determined, the loudness distribution for the media data fragment is subjected to analyzing and processing to obtain the loudness distribution result corresponding to the media data fragment. Because the media data fragment is a fragment of the media data corresponding to the speech data, the loudness distribution result corresponding to the media data fragment may be directly used as the speech loudness distribution result corresponding to the speech data.

In some examples, when there are a plurality of media data fragments, it indicates the presence of a plurality of discrete fragments of speech data in the media data. Therefore, in order to ensure the loudness equalization effect of the speech data, the process of determining the speech loudness distribution result corresponding to the speech data includes: sequentially fusing a current loudness distribution result with a previous loudness distribution result in accordance with a sequence of the plurality of media data fragments, and taking a fusion result as a previous loudness distribution result to be fused that corresponds to a next loudness distribution result, to obtain the speech loudness distribution result corresponding to the speech data.

For ease of understanding, the following will be illustrated by way of example: during speech detection on the media data, in response to a media data fragment A being a first detected speech data, a loudness distribution result of the media data fragment A is used as an initial speech loudness distribution result corresponding to the speech data. The speech detection is continuously performed on the media data, in response to detecting that a media data fragment B is also speech data, a loudness distribution result of the media data fragment B is fused with the loudness distribution result of the media data fragment A, and the fusion result is taken as a previous loudness distribution result to be fused that corresponds to a next loudness distribution result. In the process of continuing the detection, a media data fragment C is also detected as speech data, a loudness distribution result of the media data fragment C is fused with the fusion result of the media data fragment B, and their fusion result is taken as a previous loudness distribution result to be fused that corresponds to a next loudness distribution result, and so on until the end of the speech detection, and a final fusion result is taken as the speech loudness distribution result corresponding to the speech data.

When no new speech data is detected after detecting the media data fragment B until the end of the speech detection, the fusion result of the loudness distribution result of the media data fragment B and the loudness distribution result of the media data fragment A is taken as an intermediate speech loudness distribution result corresponding to the speech data.

The loudness distribution result corresponding to the speech data is determined by the above method, so that the interference of redundant media data such as background sound data or mute data on the analysis of the speech loudness distribution can be reduced effectively, thereby helping to improve the reliability and accuracy of the speech loudness distribution result and providing favorable data support for the subsequent speech loudness equalization processing.

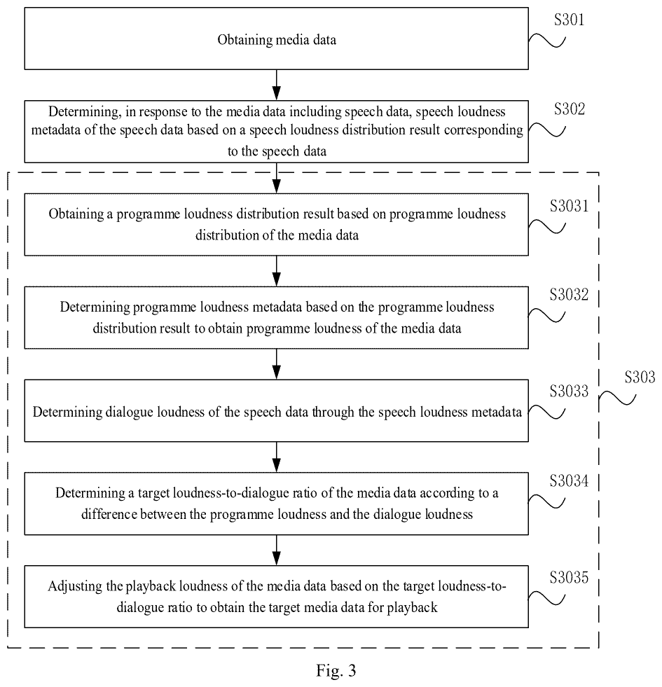

In the present embodiment, a playback loudness processing method of media data is provided, which may be used in a mobile terminal described above, such as a cellphone and a tablet PC. FIG. 3 is a flowchart of a playback loudness processing method of media data according to an embodiment of the present disclosure. As illustrated by FIG. 3, the process includes the following steps.
Step S301: obtaining media data. See the step S101 of the embodiment shown in FIG. 1 for details, which will not be repeated here.
Step S302: determining, in response to the media data including speech data, speech loudness metadata of the speech data based on a speech loudness distribution result corresponding to the speech data. See the step S102 of the embodiment shown in FIG. 1 for details, which will not be repeated here.
Step S303: adjusting playback loudness of the media data based on the speech loudness metadata to obtain target media data for playback.

Specifically, the above step S303 includes:
Step S3031: obtaining a programme loudness distribution result based on programme loudness distribution of the media data.

In order to ensure the effectiveness of speech loudness equalization, the programme loudness distribution of the media data is analyzed to determine the programme loudness distribution of the media data, thus obtaining the programme loudness distribution result.
Step S3032: determining programme loudness metadata based on the programme loudness distribution result to obtain programme loudness of the media data.

Speech descriptive information such as integrated loudness, loudness range, and loudness variation of the media data may be determined based on the programme loudness distribution of the media data, to obtain the programme loudness metadata capable of characterizing the overall audio feature of the media data, so that the programme loudness (PL) of the media data may be obtained according to a result of subsequent analysis on the programme loudness metadata. The programme loudness may be obtained by analyzing the programme loudness metadata by a predetermined algorithm or standard. For example, the programme loudness metadata may be subjected to analyzing and processing by mapping the programme loudness metadata to a certain loudness measurement or using a certain loudness evaluation model, thereby obtaining a final loudness value.

In some examples, the content of the programme loudness metadata includes, but is not limited to, any one or more of the following information: loudness range (LRA), integrated loudness (integrated_loudness), start loudness of the loudness range (LRA_start), end loudness of the loudness range (LRA_end), maximum momentary loudness (max_mom_loud), maximum short-term loudness (max_short_term_loud), and the like of the media data.
Step S3033: determining dialogue loudness of the speech data through the speech loudness metadata.

The dialogue loudness (DL) of the speech data may be obtained according to an analyzing result the speech loudness metadata. For example, the dialogue loudness may be obtained after the speech loudness metadata is subjected to analyzing and processing by a predetermined algorithm or standard.
Step S3034: determining a target loudness-to-dialogue ratio of the media data according to a difference between the programme loudness and the dialogue loudness.

Based on the audio playback standard, it can be clarified that the loudness-to-dialogue ratio (LDR) is determined according to the difference between PL and DL. Therefore, when the programme loudness of the media data and the dialogue loudness of the speech data are determined, the difference between the two is used as the loudness-to-dialogue ratio for the media data.

The formula for determining the target loudness-to-dialogue ratio may be: LDR=PL−DL.
Step S3035: adjusting the playback loudness of the media data based on the target loudness-to-dialogue ratio to obtain the target media data for playback.

A balance relationship between the dialogue loudness and the programme loudness range during the loudness equalization processing of the speech data may be determined with the target loudness-to-dialogue ratio, thereby enabling to ensure the loudness of speech data being equalized relatively rather than being too loud or weak in the process of playing speech data of the target media data, thereby effectively improving the playback effect of the target media data and improving user experiences.

In the playback loudness processing method of media data of the present embodiment, because the speech loudness metadata is determined based on the speech loudness distribution result, and the programme loudness metadata is determined based on the programme loudness distribution result, the loudness of the speech and the overall media data can be described accurately. By comparing the dialogue loudness to the programme loudness range, the target loudness-to-dialogue ratio is determined, which enables the media data to be played after adjusting with appropriate playback loudness, thereby bringing better listening experience.

In some optional implementations, the above step S3035 includes:
Step b1: obtaining target playback loudness of the speech data;
Step b2: determining a dynamic range control parameter of the media data based on the target playback loudness, the dialogue loudness, and the target loudness dialog ratio;
and Step b3: adjusting the playback loudness of the media data based on the dynamic range control parameter to obtain the target media data for playback.

Specifically, the target playback loudness of the speech data may be determined based on loudness demand information. The loudness demand information includes a current playback environment. The noisier the current playback environment, the louder the target playback will be. In the process of determining the target playback loudness, the target playback loudness may be determined in conjunction with the noise level of the current playback environment, or the playback capability of the playback device.

Because the dialogue loudness of the speech data corresponds to different loudness magnitudes at different moments, in order to equalize the loudness of the speech data, a dynamic range control parameter of the media data is determined based on the target playback loudness, the dialogue loudness, and the target loudness-to-dialogue ratio, and then the playback loudness of the media data is adjusted based on the dynamic range control parameter, which enables the dynamic adjustment and may obtain the target media data capable of enhancing the auditory effect.

In some examples, the dynamic range control parameter includes a dynamic range compression ratio, and thus the above step b3 includes:
Step b31: determining a first loudness compression ratio according to a ratio of the dialogue loudness to the target playback loudness;
Step b32: determining a second loudness compression ratio according to a ratio of the target loudness dialog ratio to a specified loudness dialog ratio; and
Step b33: determining a dynamic range compression ratio based on a comparison result between the first loudness compression ratio and the second loudness compression ratio.

Specifically, the dialogue loudness is the true loudness level of the speech data, and the target playback loudness is the desired playback loudness. The first loudness compression ratio indicating the actual loudness difference may be obtained by calculating the ratio between the dialogue loudness and the target playback loudness. With the first loudness compression ratio, it may be determined how much compression of the dialogue loudness of the speech data is needed to allow the dialogue loudness to be close to the target playback loudness. That is, the first loudness compression ratio is ratio1=dialogue loudness anchor_lra/target playback loudness target_lra.

The specified loudness-to-dialogue ratio is a preset standard or reference ratio. The specified loudness-to-dialogue ratio may be determined based on a loudness-to-dialogue ratio range criterion. For example, in response to the loudness-to-dialogue ratio range criterion being 4 to 8 LU, the specified loudness-to-dialogue ratio may be any of the values from 4 to 8 LU, such as 5 LU. The specified loudness-to-dialogue ratio may be set according to actual needs.

The second loudness compression ratio is obtained by calculating the ratio between the target loudness-to-dialogue ratio and the specified loudness-to-dialogue ratio, so that it can be clarified how to adjust the compression of the dynamic range, to achieve the purpose of realizing the target loudness-to-dialogue ratio. That is, the second loudness compression ratio is ratio2=target loudness-to-dialogue ratio LDR/specified loudness-to-dialogue ratio.

The dynamic range compression ratio determines the degree of dynamic compression of the actual loudness range. Therefore, the approach of determining the dynamic range compression ratio based on a comparison result between the first loudness compression ratio and the second loudness compression ratio enables a more flexible determination process of the compression ratio and helps to improve the listening effect after adjustment. For example, one of the loudness compression ratios may be selected or a weighting average approach may be used to determine a final dynamic range compression ratio, thereby adjusting the equalization of the programme loudness.

Preferably, the loudness compression ratio that is a larger loudness compression ratio among the first loudness compression ratio and the second loudness compression ratio may be used as the dynamic range compression ratio, which helps to improve the efficiency in determining the compression ratio. Moreover, with the determined compression ratio, the purpose of realizing the target loudness-to-dialogue ratio may be achieved, and the dialogue loudness is allowed to be close to the target playback loudness.

In some other examples, the dynamic range control parameter further includes a static characteristic threshold. Thus, start loudness of the dialogue loudness may also be determined through the speech loudness metadata, and the start loudness may be used as the static characteristic threshold, ensuring that the dynamic range after adjusting is determined based on the start loudness of the actual speech, further ensuring that the adjusted dialogue loudness is adjusted based on the same start loudness, thereby keeping consistency of speech loudness more effectively and achieving more stable and stable loudness of the speech data.

In some other optional implementations, the above step S3035 further includes:
Step c1: obtaining reference loudness of the speech data;
Step c2: determining a speech loudness gain of the speech data based on a difference between the reference loudness and the dialogue loudness; and
Step c3: adjusting the playback loudness of the media data based on the speech loudness gain and the dynamic range control parameter to obtain the target media data for playback.

Specifically, the reference loudness may be a fixed value determined according to some standard or setting, or a dynamic value determined based on the current playback environment or the user's demand, which is used as a reference value for adjusting the speech loudness.

According to the difference between the reference loudness and the dialogue loudness, the numerical value relationship between the reference loudness and the dialogue loudness and the direction of loudness adjustment can be determined, thereby obtaining the speech loudness gain for adjusting the dialogue loudness. For example, in response to the dialogue loudness being less than the reference loudness, the difference obtained is positive, indicating that the dialogue loudness needs to be increased according to the difference value, thereby obtaining the speech loudness gain for processing the speech data. In response to the dialogue loudness being greater than the reference loudness, the difference obtained is a negative value, indicating that the dialogue loudness needs to be decreased according to the difference, thereby obtaining the speech loudness gain for processing the processed speech data. By determining the speech loudness gain in this manner, the dialogue loudness of the speech data may be appropriately adjusted according to the actual situation. Based on the speech loudness gain and the dynamic range control parameter, the playback loudness of the media data can be adjusted more accurately, which may effectively reduce the occurrence of over-amplification or over-compression of the dialogue loudness, so that the target media data obtained for playback is more conducive to improving the user's listening experience.

In some optional scenarios, in response to the reference loudness being 50 dB and the dialogue loudness being 40 dB, the speech loudness gain is gain=50 dB−40 dB=+10 dB. In the process of adjusting the dialogue loudness of the speech data, the dialogue loudness needs to be increased by way of amplifying or attenuating the loudness of the speech data, enabling the adjusted dialogue loudness to meet the expectation.

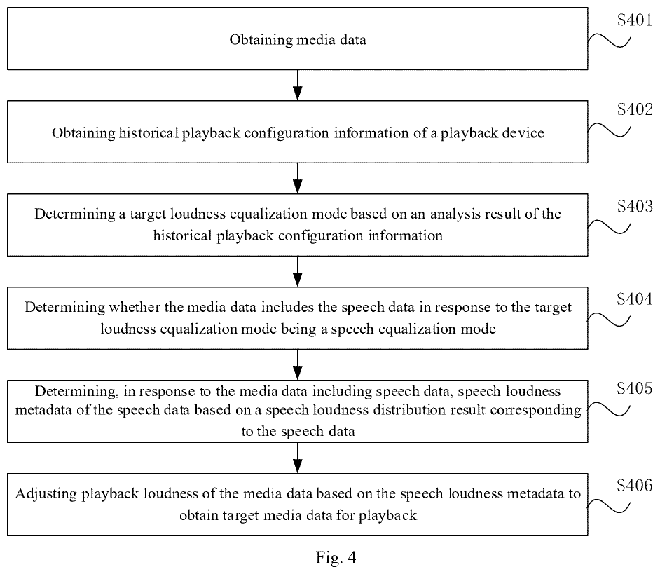

In the present embodiment, a playback loudness processing method of media data is provided, which may be used in a mobile terminal described above, such as a cellphone and a tablet PC. FIG. 4 is a flowchart of a playback loudness processing method of media data according to an embodiment of the present disclosure. As illustrated by FIG. 4, the process includes the following steps.
Step S401: obtaining media data.
Step S402: obtaining historical playback configuration information of a playback device.

The playback device is a device for playing the target media data, and the historical playback configuration information may include, but is not limited to, information such as external loudness configuration parameters and playback modes of the playback device during the historical playback of the media data. The external playback loudness configuration parameters indicate how the user set the volume of the device during the historical playback. For example, the user may turn the volume up or down at different times or occasions. The playback modes, on the other hand, may include, such as a speaker mode (using a built-in speaker or external speaker), and a headphone mode. The selection of these modes also affects the audio playback effect.
Step S403: determining a target loudness equalization mode based on an analysis result of the historical playback configuration information.

According to an analyzing result the historical playback configuration information, the user's preference for volume during historical use of the playback device can be clarified, and then a suitable equalization mode can be selected as the target loudness equalization mode, thereby helping to ensure that the dialogue loudness after subsequent adjustments meets the user's expectation well.

The target loudness equalization mode may include, but is not limited to, any of the following equalization modes: a speech equalization mode, and a default equalization mode. The speech equalization mode may be understood as an equalization mode that prefers to be able to play the speech data clearly and needs to perform loudness equalization on the dialogue loudness of the speech data. The default equalization mode may be understood as a general equalization mode that performs programme loudness equalization for media to be played.
Step S404: determining whether the media data includes the speech data in response to the target loudness equalization mode being a speech equalization mode.
Step S405: determining, in response to the media data including speech data, speech loudness metadata of the speech data based on a speech loudness distribution result corresponding to the speech data.
Step S406: adjusting playback loudness of the media data based on the speech loudness metadata to obtain target media data for playback.

In the playback loudness processing method of media data of the present embodiment, the target loudness equalization mode is determined with the historical playback configuration information of the playback device, and the playback loudness of the media data is adjusted based on the speech loudness metadata when the target loudness equalization mode is the speech equalization mode, enabling the dialogue loudness after adjusting to meet expectation well during the playback of the adjusted target media data, thereby helping to improve the user experience.

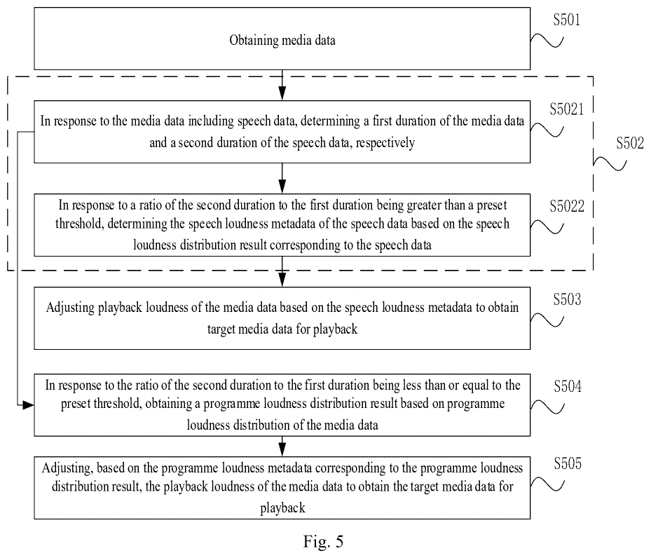

In the present embodiment, a playback loudness processing method of media data is provided, which may be used in a mobile terminal described above, such as a cellphone and a tablet PC. FIG. 5 is a flowchart of a playback loudness processing method of media data according to an embodiment of the present disclosure. As illustrated by FIG. 5, the process includes the following steps.
Step S501: obtaining media data.
Step S502: determining, in response to the media data including speech data, speech loudness metadata of the speech data based on a speech loudness distribution result corresponding to the speech data.

Specifically, the above step S502 includes:
Step S5021: in response to the media data including speech data, determining a first duration of the media data and a second duration of the speech data, respectively.

To determine the distribution of the speech data in the media data, the first duration of the media data and the second duration of the speech data are determined, respectively. The first duration is understood as a total playback duration of the media data and the second duration is understood as a total playback duration of the speech data. The second duration is less than or equal to the first duration.
Step S5022: in response to a ratio of the second duration to the first duration being greater than a preset threshold, determining the speech loudness metadata of the speech data based on the speech loudness distribution result corresponding to the speech data.

When the ratio between the second duration and the first duration is greater than the preset threshold value, it indicates that there is a relatively large amount of speech data in the media data and that loudness equalization on the speech data is valid. Therefore, in order to make the dialogue loudness of the speech data more balanced, the speech loudness metadata of the speech data is determined based on the speech loudness distribution result corresponding to the speech data. The preset threshold value may be determined according to actual needs. For example, the preset threshold may be 15%.
Step S503: adjusting playback loudness of the media data based on the speech loudness metadata to obtain target media data for playback.

In the playback loudness processing method of media data of the present embodiment, when it is determined that the ratio between the second ratio and the first ratio is greater than the preset threshold, it can be ensured that the loudness equalization performed for the speech data is valid by adjusting the playback loudness of the media data based on the speech loudness metadata, thereby ensuring the playback effect of the media data.

In some optional implementations, the above method further includes:
Step S504: in response to the ratio of the second duration to the first duration being less than or equal to the preset threshold, obtaining a programme loudness distribution result based on programme loudness distribution of the media data.

When the ratio between the second duration and the first duration is less than or equal to the preset threshold, it indicates that there is a relatively small amount of speech data in the media data. If the loudness equalization processing continues to be performed for the speech data, it will have little effect and belongs to invalid processing. Therefore, in order to ensure that the programme loudness of the media data can be equalized, the programme loudness distribution of the media data is analyzed, and thus the programme loudness distribution result that reflects the programme loudness distribution of the media data is obtained.
Step S505: adjusting, based on the programme loudness metadata corresponding to the programme loudness distribution result, the playback loudness of the media data to obtain the target media data for playback.

With the programme loudness metadata, the programme loudness distribution of the media data can be determined. Accordingly, when the playback loudness of the media data is adjusted, the overall playback loudness can be equalized, so as to improve the playback effect of the media data.

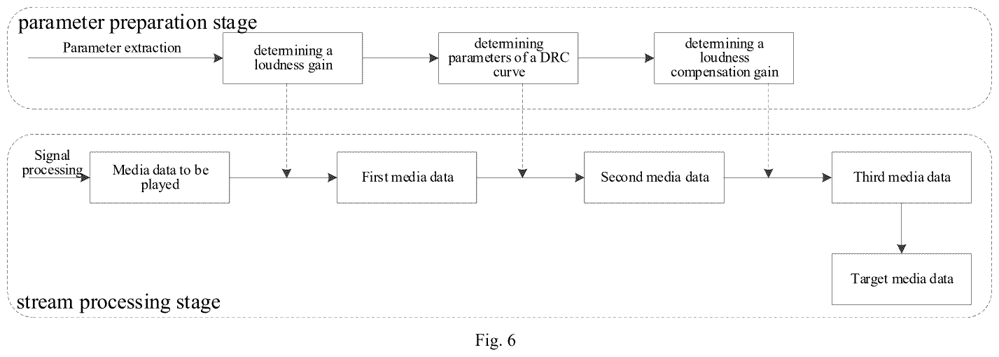

As one or more specific implementations of the embodiment of the present disclosure, FIG. 6 shows a process flow of the media data, and the whole process may include a parameter preparation stage as well as a stream processing stage. The preparation stage includes: determining a loudness gain, determining parameters of a DRC curve, and determining a loudness compensation gain. The streaming processing stage includes: utilizing the loudness gain to perform loudness gain processing on the media data to obtain first media data; utilizing the parameters of the DRC curve to obtain a DRC curve, and then utilizing the DRC curve to perform dynamic range control processing on the first media data to obtain second media data; performing loudness compensation on the second media data with the loudness compensation gain to obtain third media data; and finally, performing peak limiting on the third media data to obtain target media data.

In the process of determining the loudness gain, in response to the target equalization mode being the speech equalization mode, it is determined that the loudness gain is a speech loudness gain. In response to the target equalization mode being the default equalization mode, it is determined that the determined loudness gain is a programme loudness gain.

The loudness equalization processing is performed by the playback loudness processing method of media data, so that the loudness adjustment method is more flexible, the targeted loudness equalization processing may be performed for the speech data or the overall data of the media data, the playback effect of the media data can be improved effectively, and the final playback loudness can meet user's expectation, thereby achieving the purpose of improving the listening effect.

Further provided in the present embodiment is a playback loudness processing apparatus of media data. The apparatus is used for implementing the above embodiments and preferred embodiments. What has already been described will not be repeated. As used hereinafter, the term “module” may be a combination of software and/or hardware that implements a predetermined function. Although the apparatus described in the following embodiment is preferably implemented in software, implementations of hardware or a combination of software and hardware are also possible and conceived.

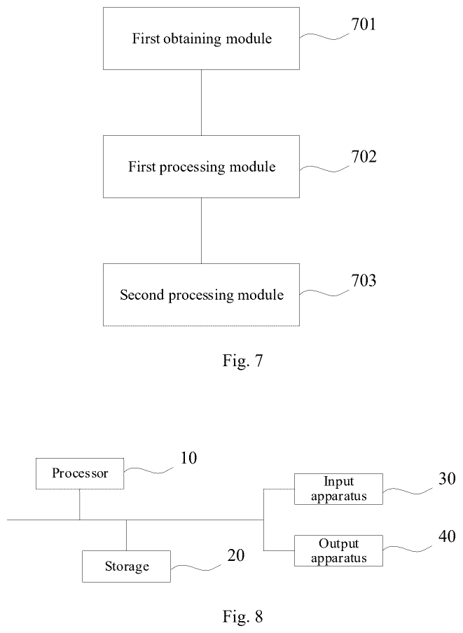

This embodiment provides a playback loudness processing apparatus of media data. As illustrated by FIG. 7, the apparatus includes:
a first obtaining module 701 configured to obtain media data;
a first processing module 702 configured to determine, in response to the media data including speech data, speech loudness metadata of the speech data based on a speech loudness distribution result corresponding to the speech data; and
a second processing module 703 configured to adjust playback loudness of the media data based on the speech loudness metadata to obtain target media data for playback.

In some optional implementations, an apparatus for determining the speech loudness distribution result corresponding to the speech data includes:
a first detection module configured to perform speech detection on the media data to determine a media data fragment corresponding to the speech data in the media data;
a second detection module configured to determine loudness distribution of the media data fragment to obtain a loudness distribution result; and
a third detection module configured to determine the speech loudness distribution result corresponding to the speech data according to the loudness distribution result.

In some optional implementations, in response to a plurality of media data fragments, the third detection module includes:
a first processing unit configured to sequentially fuse a current loudness distribution result with a previous loudness distribution result in accordance with a sequence of the plurality of media data fragments, and take a fusion result as a previous loudness distribution result to be fused that corresponds to a next loudness distribution result, to obtain the speech loudness distribution result corresponding to the speech data.

In some optional implementations, the second processing module 703 includes:
an analysis module configured to obtain a programme loudness distribution result based on programme loudness distribution of the media data;
a second processing unit configured to determine programme loudness metadata based on the programme loudness distribution result to obtain programme loudness of the media data;
a third processing unit configured to determine dialogue loudness of the speech data through the speech loudness metadata;
a fourth processing unit configured to determine a target loudness-to-dialogue ratio of the media data according to a difference between the programme loudness and the actual speech loudness; and
a fifth processing unit configured to adjust the playback loudness of the media data based on the target loudness-to-dialogue ratio to obtain the target media data for playback.

In some optional implementations, the fifth processing unit includes:
a first obtaining unit configured to obtain target playback loudness of the speech data;
a parameter determination unit configured to determine a dynamic range control parameter of the media data based on the target playback loudness, the dialogue loudness, and the target loudness dialog ratio; and
an adjustment unit configured to adjust the playback loudness of the media data based on the dynamic range control parameter to obtain the target media data for playback.

In some optional implementations, the dynamic range control parameter includes a dynamic range compression ratio, and a second execution unit includes:
a first determination unit configured to determine a first loudness compression ratio according to a ratio of the dialogue loudness to the target playback loudness;
a second determination unit configured to determine a second loudness compression ratio according to a ratio of the target loudness dialog ratio to a specified loudness dialog ratio; and
a third determination unit configured to determine a dynamic range compression ratio based on a comparison result between the first loudness compression ratio and the second loudness compression ratio.

In some optional implementations, the third determination unit includes:
a third determination subunit configured to take a larger loudness compression ratio among the first loudness compression ratio and the second loudness compression ratio as a compression ratio for the dynamic range.

In some optional implementations, the dynamic range control parameter further includes a static characteristic threshold, and the second execution unit further includes:
a fourth determination unit configured to determine start loudness of the dialogue loudness through the speech loudness metadata;
and a fifth determination unit configured to use the start loudness as the static characteristic threshold.

In some optional implementations, the fifth processing unit further includes:
a second obtaining unit configured to obtain reference loudness of the speech data;
a sixth processing unit configured to determine a speech loudness gain of the speech data based on a difference between the reference loudness and the dialogue loudness; and
a seventh processing unit configured to adjust the playback loudness of the media data based on the speech loudness gain and the dynamic range control parameter to obtain the target media data for playback.

In some optional implementations, after obtaining media data, the apparatus further includes:
a second obtaining module configured to obtain historical playback configuration information of a playback device, the playback device being a device for playing the target media data;
a third processing module configured to determine a target loudness equalization mode based on a analyzing result the historical playback configuration information; and
a fourth processing module configured to determine whether the media data includes the speech data in response to the target loudness equalization mode being a speech equalization mode.

In some optional implementations, the first processing module 702 includes:
a statistics module configured to determine a first duration of the media data and a second duration of the speech data, respectively; and
a fifth processing module configured to, in response to a ratio of the second duration to the first duration being greater than a preset threshold, determine the speech loudness metadata of the speech data based on the speech loudness distribution result corresponding to the speech data.

In some optional implementations, the apparatus further includes:
a sixth processing module configured to, in response to a ratio of the second duration to the first duration being greater than a preset threshold, determine the speech loudness metadata of the speech data based on the speech loudness distribution result corresponding to the speech data; and
a seventh processing module configured to adjust the playback loudness of the media data based on the programme loudness metadata corresponding to the programme loudness distribution result to obtain the target media data for playback.

Further functional descriptions of the respective modules and units described above are the same as those of the corresponding embodiments and will not be repeated herein.

The playback loudness processing apparatus of media data in the present embodiment is presented in the form of functional units, where the units refer to an ASIC (Application Specific Integrated Circuit), a processor and a memory executing one or more software or fixed programs, and/or other devices that can provide the above-described functions.

An embodiment of the present disclosure further provides an electronic device, including the playback loudness processing apparatus of media data as illustrated by FIG. 7 above.

Referring to FIG. 8, FIG. 8 is a schematic structural diagram of an electronic device according to an optional embodiment of the present disclosure. As illustrated by FIG. 8, the electronic device includes one or more processors 10, a memory 20, and interfaces for connecting various components, including a high-speed interface and a low-speed interface. The respective components are communicatively connected to each other via different buses and may be mounted on a common motherboard or mounted by other means as needed. The processor may process an instruction executed within the electronic device, the instruction including an instruction stored in or on a memory to display graphical information of a GUI on an external input/output apparatus (e.g., a display device coupled to the interface). In some optional implementations, a plurality of processors and/or a plurality of buses may be used with a plurality of memories, if desired. Similarly, multiple electronic devices may be connected, and the respective devices provide some of the necessary operations (e.g., as an array of servers, a set of blade servers, or a multiprocessor system). FIG. 8 shows one processor 10 as an example.

The processor 10 may be a central processor, a network processor, or a combination thereof. The processor 10 may further include a hardware chip. The hardware chip may be a specialized integrated circuit, a programmable logic device, or a combination thereof. The programmable logic device may be a complex programmable logic device, a field programmable logic gate array, a general purpose array logic or any combination thereof.

The memory 20 stores an instruction executable by the at least one processor 10 to cause the at least one processor 10 to perform the method illustrated in the above embodiments.

The memory 20 may include a program store and a data store. The program store may store an operating system, and an application program needed by at least one function. The data store may store data created based on use of the electronic device, and the like. In adding, the memory 20 may include a high-speed random access memory, and may further include a non-instant memory, for example, at least one disk memory device, flash memory device, or other non-instant solid state memory device. In some optional implementations, the memory 20 optionally includes memories remotely located relative to the processor 10, and these remote memories may be connected to the electronic device via networks. Examples of the networks include, but are not limited to, the Internet, an enterprise intranet, a local area network, a mobile communications network, and a combination thereof.

The memory 20 may include a volatile memory, e.g., random access memory; the memory may further include a non-volatile memory, e.g., a flash memory, a hard disk, or a solid state drive; and the memory 20 may further include a combination of the types of memories described above.

The electronic device further includes an input apparatus 30 and an output apparatus 40. The processor 10, the memory 20, the input apparatus 30, and the output apparatus 40 may be connected via a bus or by other means. FIG. 8 shows the connection via a bus as an example.

The input apparatus 30 may receive input numeric or character information, and generate key signal inputs related to user settings as well as function control of the electronic device, such as a touch screen, a keypad, a mouse, a track pad, a touch pad, an indicator bar, one or more mouse buttons, a track ball, and a joystick. The output apparatus 40 may include a display device, an auxiliary lighting apparatus (e.g., an LED), and a tactile feedback apparatus (e.g., a vibration motor), and the like. The above display device includes, but is not limited to, a liquid crystal display, a light emitting diode, a monitor, and a plasma display. In some optional implementations, the display device may be a touch screen.

The embodiments of the present disclosure also provide a computer-readable storage medium. The methods according to the embodiments of the present disclosure may be implemented in hardware or firmware, or may be recorded on a storage medium, or may be implemented as computer code originally stored in a remote storage medium or non-transitory machine-readable storage medium and to be downloaded through a network and stored in a local storage medium. Thus, the methods described herein may be stored on a storage medium using a general-purpose computer, a dedicated processor, or programmable or dedicated hardware for such software processing. The storage medium may be a magnetic disk, optical disc, read-only memory, random access memory, flash memory, hard disk, or solid-state drive, etc. Furthermore, the storage medium may also include a combination of the aforementioned types of memory. It should be understood that computers, processors, microprocessor controllers, or programmable hardware include storage components that can store or receive software or computer code. When the software or computer code is accessed and executed by a computer, processor, or hardware, the methods shown in the above embodiments are implemented. The computer-readable medium can be any available computer-readable storage medium or communication medium accessible by a computer.

The embodiments of the present disclosure also provide a computer-readable storage medium. The methods according to the embodiments of the present disclosure may be implemented in hardware or firmware, or may be recorded on a storage medium, or may be implemented as computer code originally stored in a remote storage medium or non-transitory machine-readable storage medium and to be downloaded through a network and stored in a local storage medium. Thus, the methods described herein may be stored on a storage medium using a general-purpose computer, a dedicated processor, or programmable or dedicated hardware for such software processing. The storage medium may be a magnetic disk, optical disc, read-only memory, random access memory, flash memory, hard disk, or solid-state drive, etc. Furthermore, the storage medium may also include a combination of the aforementioned types of memory. It should be understood that computers, processors, microprocessor controllers, or programmable hardware include storage components that can store or receive software or computer code. When the software or computer code is accessed and executed by a computer, processor, or hardware, the methods shown in the above embodiments are implemented. The computer-readable medium can be any available computer-readable storage medium or communication medium accessible by a computer.

It should be understood that, before using the technical solutions disclosed in the embodiments of the present disclosure, the types, scope of use, and usage scenarios of personal information involved in the present disclosure should be informed to users and their authorization should be obtained in an appropriate manner in accordance with relevant laws and regulations.

For example, in response to receiving an active request from a user, a prompt message is sent to the user to explicitly inform the user that the requested operation will require obtaining and using the user's personal information. Thus, users can independently decide whether to provide personal information to electronic devices, applications, servers, or storage media, etc., which are software or hardware executing the technical solutions of the present disclosure, based on the prompt message.

As an optional but non-limiting implementation, the way of sending a prompt message to the user in response to receiving an active request from the user can be, for example, in the form of a pop-up window. The prompt message can be presented in the pop-up window in text form. In addition, the pop-up window can also include selection controls for users to choose whether to “agree” or “disagree” to provide personal information to the electronic device.

It should be understood that the above notification and user authorization process is only illustrative and does not limit the implementation of the present disclosure. Other methods that meet relevant laws and regulations can also be applied to the implementation of the present disclosure.

Although the embodiments of the present disclosure have been described with reference to the drawings, those skilled in the art can make various modifications and variations without departing from the spirit and scope of the present disclosure. Such modifications and variations are within the scope defined by the appended claims.

1. A playback loudness processing method of media data, comprising:
obtaining media data;
determining, in response to the media data comprising speech data, speech loudness metadata of the speech data based on a speech loudness distribution result corresponding to the speech data; and
adjusting playback loudness of the media data based on the speech loudness metadata to obtain target media data for playback.

2. The playback loudness processing method according to claim 1, wherein before determining, in response to the media data comprising speech data, speech loudness metadata of the speech data based on the speech loudness distribution result corresponding to the speech data, the method further comprises: determining the speech loudness distribution result corresponding to the speech data,
the determining the speech loudness distribution result corresponding to the speech data comprises:
performing speech detection on the media data to determine a media data fragment corresponding to the speech data in the media data;
determining loudness distribution of the media data fragment to obtain a loudness distribution result; and
determining the speech loudness distribution result corresponding to the speech data according to the loudness distribution result.

3. The playback loudness processing method according to claim 2, wherein, in response to a plurality of media data fragments, the determining the speech loudness distribution result corresponding to the speech data according to the loudness distribution result comprises:
sequentially fusing a current loudness distribution result with a previous loudness distribution result in accordance with a sequence of the plurality of media data fragments, and taking a fusion result as a previous loudness distribution result to be fused that corresponds to a next loudness distribution result, to obtain the speech loudness distribution result corresponding to the speech data.

4. The playback loudness processing method according to claim 1, wherein the adjusting playback loudness of the media data based on the speech loudness metadata to obtain the target media data for playback comprises:
obtaining a programme loudness distribution result based on programme loudness distribution of the media data;
determining programme loudness metadata based on the programme loudness distribution result to obtain programme loudness of the media data;
determining dialogue loudness of the speech data through the speech loudness metadata;
determining a target loudness-to-dialogue ratio of the media data according to a difference between the programme loudness and the dialogue loudness; and
adjusting the playback loudness of the media data based on the target loudness-to-dialogue ratio to obtain the target media data for playback.

5. The playback loudness processing method according to claim 4, wherein the adjusting the playback loudness of the media data based on the target loudness-to-dialogue ratio to obtain the target media data for playback comprises:
obtaining target playback loudness of the speech data;
determining a dynamic range control parameter of the media data based on the target playback loudness, the dialogue loudness, and the target loudness-to-dialogue ratio; and
adjusting the playback loudness of the media data based on the dynamic range control parameter to obtain the target media data for playback.

6. The playback loudness processing method according to claim 5, wherein the dynamic range control parameter comprises a dynamic range compression ratio, and the determining the dynamic range control parameter of the media data based on the target playback loudness, the dialogue loudness, and the target loudness-to-dialogue ratio comprises:
determining a first loudness compression ratio according to a ratio of the dialogue loudness to the target playback loudness;
determining a second loudness compression ratio according to a ratio of the target loudness-to-dialogue ratio to a specified loudness-to-dialogue ratio; and
determining the dynamic range compression ratio based on a comparison result between the first loudness compression ratio and the second loudness compression ratio.

7. The playback loudness processing method according to claim 6, wherein the determining the dynamic range compression ratio based on the comparison result between the first loudness compression ratio and the second loudness compression ratio comprises:
taking a larger loudness compression ratio among the first loudness compression ratio and the second loudness compression ratio as the dynamic range compression ratio.

8. The playback loudness processing method according to claim 6, wherein the dynamic range control parameter further comprises a static characteristic threshold, and the determining the dynamic range control parameter of the media data based on the target playback loudness, the dialogue loudness, and the target loudness-to-dialogue ratio further comprises:
determining start loudness of the dialogue loudness through the speech loudness metadata; and
using the start loudness as the static characteristic threshold.

9. The playback loudness processing method according to claim 5, wherein the adjusting the playback loudness of the media data based on the target loudness-to-dialogue ratio to obtain the target media data for playback further comprises:
obtaining reference loudness of the speech data;
determining a speech loudness gain of the speech data based on a difference between the reference loudness and the dialogue loudness; and
adjusting the playback loudness of the media data based on the speech loudness gain and the dynamic range control parameter to obtain the target media data for playback.

10. The playback loudness processing method according to claim 1, wherein, after obtaining the media data, the method further comprises:
obtaining historical playback configuration information of a playback device, the playback device being a device for playing the target media data;
determining a target loudness equalization mode based on a result of analyzing the historical playback configuration information; and
determining whether the media data comprises the speech data in response to the target loudness equalization mode being a speech equalization mode.

11. The playback loudness processing method according to claim 1, wherein the determining the speech loudness metadata of the speech data based on the speech loudness distribution result corresponding to the speech data comprises:
determining a first duration of the media data and a second duration of the speech data, respectively; and
determining, in response to a ratio of the second duration to the first duration being greater than a preset threshold, the speech loudness metadata of the speech data based on the speech loudness distribution result corresponding to the speech data.

12. The playback loudness processing method according to claim 11, further comprising:
obtaining, in response to the ratio of the second duration to the first duration being less than or equal to the preset threshold, a programme loudness distribution result based on programme loudness distribution of the media data; and
adjusting the playback loudness of the media data based on the programme loudness metadata corresponding to the programme loudness distribution result to obtain the target media data for playback.

13. An electronic device, comprising:
one or more processor; and
a non-transitory storage apparatus with instructions thereon, wherein the instructions upon execution by the processor, cause the processor to perform a playback loudness processing method, and the method comprises:
obtaining media data;
determining, in response to the media data comprising speech data, speech loudness metadata of the speech data based on a speech loudness distribution result corresponding to the speech data; and
adjusting playback loudness of the media data based on the speech loudness metadata to obtain target media data for playback.

14. The electronic device according to claim 13, wherein before determining, in response to the media data comprising speech data, speech loudness metadata of the speech data based on the speech loudness distribution result corresponding to the speech data, the method further comprises: determining the speech loudness distribution result corresponding to the speech data,
the determining the speech loudness distribution result corresponding to the speech data comprises:
performing speech detection on the media data to determine a media data fragment corresponding to the speech data in the media data;
determining loudness distribution of the media data fragment to obtain a loudness distribution result; and
determining the speech loudness distribution result corresponding to the speech data according to the loudness distribution result.

15. The electronic device according to claim 14, wherein, in response to a plurality of media data fragments, the determining the speech loudness distribution result corresponding to the speech data according to the loudness distribution result comprises:
sequentially fusing a current loudness distribution result with a previous loudness distribution result in accordance with a sequence of the plurality of media data fragments, and taking a fusion result as a previous loudness distribution result to be fused that corresponds to a next loudness distribution result, to obtain the speech loudness distribution result corresponding to the speech data.

16. The electronic device according to claim 13, wherein the adjusting playback loudness of the media data based on the speech loudness metadata to obtain the target media data for playback comprises:
obtaining a programme loudness distribution result based on programme loudness distribution of the media data;
determining programme loudness metadata based on the programme loudness distribution result to obtain programme loudness of the media data;
determining dialogue loudness of the speech data through the speech loudness metadata;
determining a target loudness-to-dialogue ratio of the media data according to a difference between the programme loudness and the dialogue loudness; and
adjusting the playback loudness of the media data based on the target loudness-to-dialogue ratio to obtain the target media data for playback.

17. The electronic device according to claim 16, wherein the adjusting the playback loudness of the media data based on the target loudness-to-dialogue ratio to obtain the target media data for playback comprises:
obtaining target playback loudness of the speech data;
determining a dynamic range control parameter of the media data based on the target playback loudness, the dialogue loudness, and the target loudness-to-dialogue ratio; and
adjusting the playback loudness of the media data based on the dynamic range control parameter to obtain the target media data for playback.

18. The electronic device according to claim 17, wherein the dynamic range control parameter comprises a dynamic range compression ratio, and the determining the dynamic range control parameter of the media data based on the target playback loudness, the dialogue loudness, and the target loudness-to-dialogue ratio comprises:
determining a first loudness compression ratio according to a ratio of the dialogue loudness to the target playback loudness;
determining a second loudness compression ratio according to a ratio of the target loudness-to-dialogue ratio to a specified loudness-to-dialogue ratio; and
determining the dynamic range compression ratio based on a comparison result between the first loudness compression ratio and the second loudness compression ratio.

19. The electronic device according to claim 18, wherein the determining the dynamic range compression ratio based on the comparison result between the first loudness compression ratio and the second loudness compression ratio comprises:
taking a larger loudness compression ratio among the first loudness compression ratio and the second loudness compression ratio as the dynamic range compression ratio.

20. A computer-readable storage medium, with instructions stored thereon, wherein the instructions cause at least one processor to perform a playback loudness processing method, and the method comprises:
obtaining media data;
determining, in response to the media data comprising speech data, speech loudness metadata of the speech data based on a speech loudness distribution result corresponding to the speech data; and
adjusting playback loudness of the media data based on the speech loudness metadata to obtain target media data for playback.
